(19) United States
(12) Patent Application Publication
(10) Pub. No.: US 2017/0211454 A1
(43) Pub. Date: Jul. 27, 2017

(54) PARTICULATE SENSOR AND PARTICULATE DETECTION SYSTEM

(71) Applicant: NGK SPARK PLUG CO., LTD., Nagoya-shi (JP)

(72) Inventor: Toshiya MATSUOKA, Kaizu-shi (JP)

(73) Assignee: NGK SPARK PLUG CO., LTD., Nagoya-shi (JP)

(21) Appl. No.: 15/408,927

(22) Filed: Jan. 18, 2017

(30) Foreign Application Priority Data
Jan. 22, 2016 (JP) 2016-011115

(51) Int. Cl. F01N 11/00; G01N 27/62; G01N 15/06

(52) U.S. Cl. CPC F01N 11/007; G01N 15/0656; G01N 27/62; F01N 2560/05; F01N 2560/20

(57) ABSTRACT

A particulate sensor (10, 310) includes a flow channel forming body (25, 60, 65, 360, 365) forming a sensor internal flow channel SGW through which a gas under measurement EGI flows. The particulate sensor electrifies particulates S contained in the gas under measurement flowing through the sensor internal flow channel and detects the particulates S. The flow channel forming body (25, 60, 65) includes an inner metal tube (60, 360) and an outer metal tube (65, 365) surrounding the inner metal tube (60) from a radially outward side GDO. A tubular inter-tube gap IW between the inner metal tube and the outer metal tube forms at least a portion of the sensor internal flow channel SGW. The particulate sensor includes a heater member (100) for heating at least one of the inner metal tube and the outer metal tube.

### BACKGROUND OF THE INVENTION

1. Field of the Invention

The present invention relates to a particulate sensor for detecting particulates contained in a gas under measurement, and to a particulate detection system.

2. Description of the Related Art

Exhaust gas from an internal combustion engine (e.g., a diesel engine or a gasoline engine) may contain particulates such as soot. Such exhaust gas containing particulates is cleaned through collection of particulates by a filter. Also, when necessary, the filter is heated to a high temperature so as to remove, through burning, particulates accumulated on the filter. However, in the event of filter breakage or a like problem, unclean exhaust gas is directly emitted downstream of the filter. Thus, there has been an increasing demand for a particulate sensor capable of detecting the presence/absence or the amount of particulates contained in exhaust gas in order to directly measure the amount of particulates contained therein or to detect a malfunction of the filter.

One type of such a particulate sensor includes a flow channel forming body for forming a sensor internal flow channel through which a gas under measurement flows. Such a particulate sensor is configured to electrify particulates contained in the gas under measurement flowing through the sensor internal flow channel formed by the flow channel forming body and to detect the electrified particulates. Another type of such a particulate sensor includes an inner metal tube and an outer metal tube as a flow channel forming body, wherein the inter-tube gap between the two tubes forms at least a portion of the sensor internal flow channel. See also Patent Document 1.

[Patent Document 1] Japanese Patent Application Laid-Open (kokai) No. 2015-129712

3. Problems to be Solved by the Invention

However, such type of particulate sensor may exhibit the following problem. When particulates accumulate on the outer circumferential surface of the inner metal tube and/or the inner circumferential surface of the outer metal tube as a result of the flow of the gas under measurement through the inter-tube gap, the accumulated particulates narrow the inter-tube gap or clog the tubular gap to thereby stop the flow of the gas under measurement. In such a case, the particulate sensor becomes unable to properly detect particulates.

### SUMMARY OF THE INVENTION

The present invention has been accomplished in order to address the above problems, and an object thereof is to provide a particulate sensor which can remove particulates that have accumulated on at least one of an inner metal tube and an outer metal tube which define an inter-tube gap serving as a sensor internal flow channel, and to provide a particulate detection system including the particulate sensor.

The above object has been achieved by providing, in accordance with a first aspect of the invention, (1) a particulate sensor which comprises a flow channel forming body forming a sensor internal flow channel through which a gas under measurement flows, the particulate sensor electrifying particulates present in the sensor internal flow channel and detecting the particulates flowing through the sensor internal flow channel, wherein the flow channel forming body includes an inner metal tube and an outer metal tube surrounding the inner metal tube from a radially outer side, a tubular inter-tube gap between the inner metal tube and the outer metal tube forms at least a portion of the sensor internal flow channel, and the particulate sensor includes a heater member for heating at least one of the inner metal tube and the outer metal tube.

The particulate sensor (1) includes a heater member for heating at least one of the inner metal tube and the outer metal tube. Therefore, particulates having adhered to at least one of the inner metal tube and the outer metal tube, for example, particulates having adhered to the outer circumferential surface of the inner metal tube or the inner circumferential surface of the outer metal tube, can be heated by the heating member. As a result, the particulates having adhered can be burned and removed (burned away).

Also, a method can be employed in which even when the particulate sensor is operating (detecting particulates), the outer metal tube or the inner metal tube is heated by the heater member so as to increase the temperature of the outer metal tube or the inner metal tube to thereby restrain the particulates from adhering to the outer metal tube or the inner metal tube.

Notably, examples of the “flow channel forming body” include a double-wall metal tube composed of an inner metal tube and an outer metal tube and a triple-wall metal tube composed of an inner metal tube, an outer metal tube, and another metal tube provided on the inner side of the inner metal tube or on the outer side of the outer metal tube.

Examples of the “sensor internal flow channel” include a flow channel which extends through an inter-tube gap between the inner metal tube and the outer metal tube and a flow channel which extends through the inter-tube gap, through holes formed in the inner metal tube, and the interior of the inner metal tube.

In a preferred embodiment (2) of the particulate sensor (1) above, the heater member includes a main body member formed of an inorganic insulating material, and a heat generation resistor which is embedded in the main body member and generates heat upon energization.

In the particulate sensor (2), the heat generation resistor is embedded in the main body member formed of an inorganic insulating material. Therefore, even when the heater member is exposed to the gas under measurement such as exhaust gas, the heat generation resistor is unlikely to be oxidized or corroded. Therefore, the particulate sensor can have a long heater life.

Examples of the “inorganic insulating material” used to form the main body member include insulating ceramic such as alumina, mullite, or silicon nitride, and glass containing SiO₂, B₂O₃, BaO, etc. The “heat generation resistor” is not limited to a heat generation resistor formed of a metallic material, and may be a heat generation resistor formed of an electrically conductive ceramic or a heat generation resistor formed of a mixture of a metallic material and the same material as the “inorganic insulating material.”

In another preferred embodiment (3) of the particulate sensor (1) or (2) above, the heater member is in contact with an outer tube to-be-contacted portion of the outer metal tube and heats the outer metal tube through the outer tube to-be-contacted portion.

In the particulate sensor (3), the outer metal tube is heated through the outer tube to-be-contacted portion. Therefore, it is easy to remove particulates having accumulated on the outer metal tube, for example, particulates having accumulated on the inner circumferential surface of the outer metal tube, and to restrain adhesion of particulates to the outer metal tube by heating the outer metal tube in advance.

In yet another preferred embodiment (4) of the particulate sensor of any of (1) to (3) above, the heater member is in contact with an inner tube to-be-contacted portion of the inner metal tube and heats the inner metal tube through the inner tube to-be-contacted portion.

In the particulate sensor (4), the inner metal tube is heated through the inner tube to-be-contacted portion. Therefore, it is easy to remove particulates having accumulated on the inner metal tube, for example, particulates having accumulated on the inner circumferential surface of the inner metal tube and to restrain adhesion of particulates to the inner metal tube by heating the inner metal tube in advance.

In a second aspect, the present invention provides (5) a particulate detection system including the particulate sensor of any of (1) to (4) above, the particulate detection system further comprising means for causing ions generated by gaseous discharge to adhere to particulates contained in the gas under measurement flowing through the sensor internal flow channel to thereby generate electrified particulates, and means for detecting the amount of particulates contained in the gas under measurement based on a signal current flowing in accordance with the amount of the electrified particulates.

The particulate detection system (5) drives the above-described particulate sensor so as to cause ions generated by means of gaseous discharge to adhere to particulates to thereby produce electrified particulates, and detects the amount of particulates contained in the gas under measurement based on a signal current flowing in accordance with the amount of the electrified particulates. Therefore, the amount of the particulates can be detected without fail.

### BRIEF DESCRIPTION OF THE DRAWINGS

FIG. 1 is a longitudinal sectional view of a main portion of a particulate sensor according to an embodiment.

FIG. 2 is an exploded perspective view of the main portion of the particulate sensor according to the embodiment.

FIG. 3A is a perspective view of a first insulating spacer (heater member) according to the embodiment as viewed from the proximal end side.

FIG. 3B is a perspective view of the first insulating spacer (heater member) according to the embodiment as viewed from the distal end side.

FIG. 4 is a perspective view of a ceramic element according to the embodiment.

FIG. 5 is an exploded perspective view of the ceramic element according to the embodiment.

FIG. 6 is an explanatory view showing a schematic configuration of a circuit section of a particulate detection system according to the embodiment.

FIG. 7 is an explanatory view schematically showing introduction, electrification, and discharge of particulates in the particulate sensor according to the embodiment.

FIG. 8 is a longitudinal sectional view of a main portion of a particulate sensor according to a first modification.

FIG. 9 is a longitudinal sectional view of a main portion of a particulate sensor according to a second modification.

### DESCRIPTION OF REFERENCE NUMERALS

Reference numerals used to identify various features in the drawings include the following.

1, 301, 401: particulate detection system

10, 310, 410: particulate sensor

20: inner metallic member

25: gas introduction pipe (flow channel forming body)

30: metallic shell

40: inner tube

50: inner-tube metal connection member

60, 360, 560: inner protector (inner metal tube)

60e: gas discharge opening

360h: overlapping to-be-contacted portion (inner tube to-be-contacted portion)

560h: inner tube to-be-contacted portion

65, 365, 565: outer protector (outer metal tube)

65c: gas introduction hole

65h, 365h, 565h: outer tube to-be-contacted portion (of the outer protector)

365m, 565m: welding region

70: outer metallic member

80: mounting metallic member (outer metallic member)

80s: distal end portion

85c: contact spring portion (of the heater metal connection member)

85d: wire holding portion (of the heater metal connection member)

90: outer tube (outer metallic member)

100: first insulating spacer (heater member)

101: distal end portion

101s: contact portion

102: intermediate portion

102s: outer shoulder surface (metallic member contact surface)

104: main body member

105: heater wiring

106: heat generation resistor

107: first terminal pad (first heater terminal)

108: second terminal pad (second heater terminal)

120: ceramic element

200: circuit section

223: first heater energization circuit

EP: exhaust pipe

EG: exhaust gas

EGI: introduced gas (gas under measurement)

S: particulate

CP: ion

SC: electrified particulate

SF: adhering particulate

SGW: sensor internal flow channel

IW: inter-tube gap

PVE: ground potential

PV1: first potential

Is: signal current

AX: axial line (of the particulate sensor)

GH: longitudinal direction (along the axial line)

GK: proximal end side (in the longitudinal direction)

GS: distal end side (in the longitudinal direction)

GD: radial direction

GDO: radially outward side

GDI: radially inward side

### DETAILED DESCRIPTION OF THE PREFERRED EMBODIMENTS

### Embodiment

An embodiment of the present invention will be described with reference to the drawings. However, the present invention should not be construed as being limited thereto.

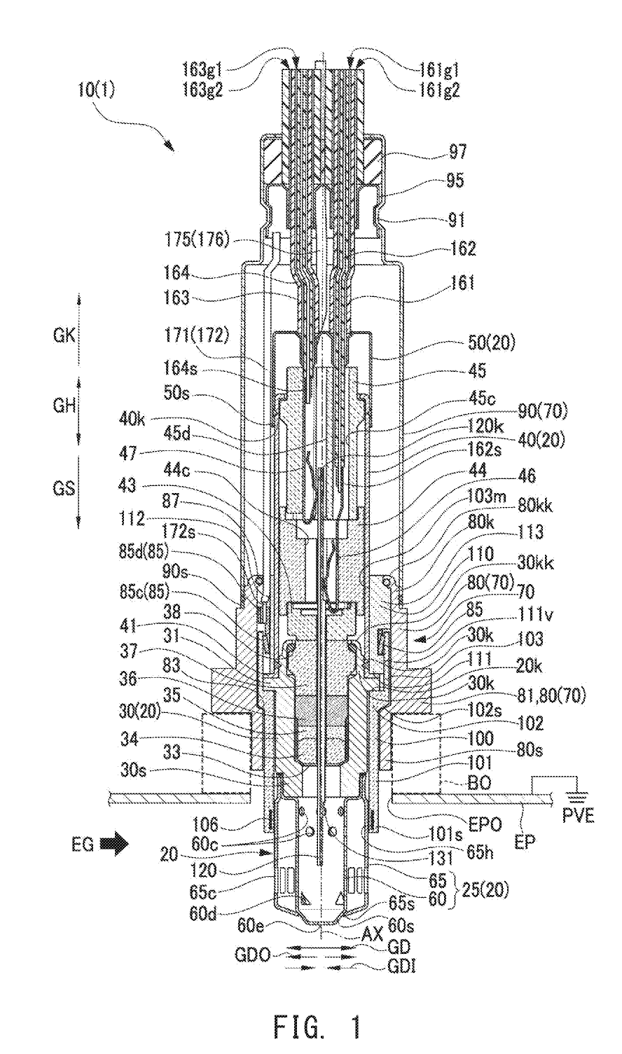

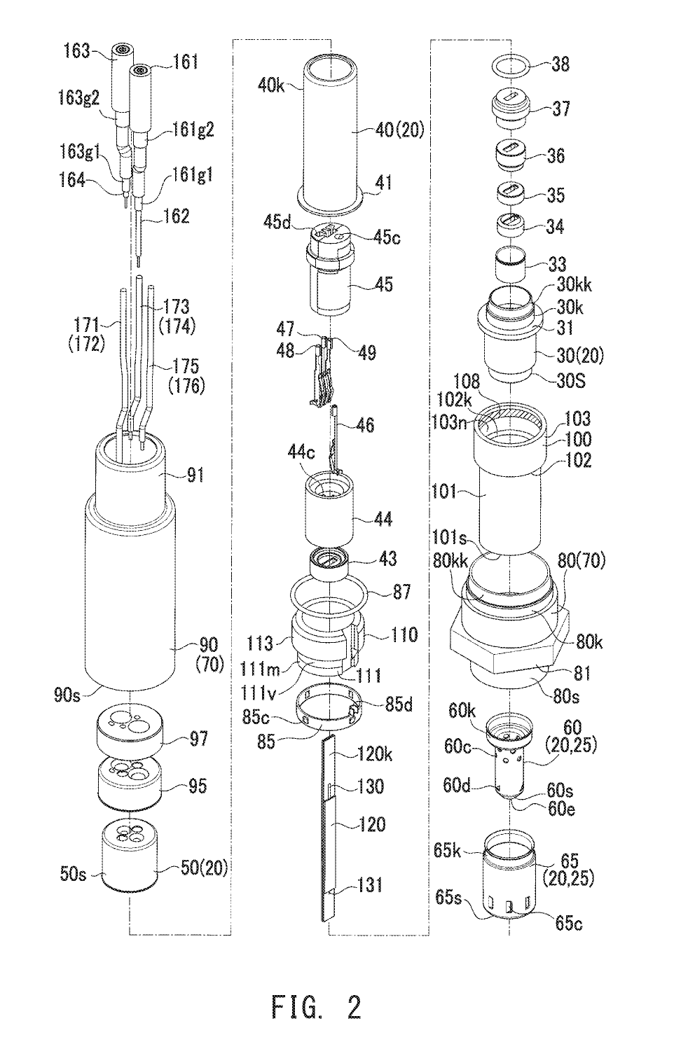

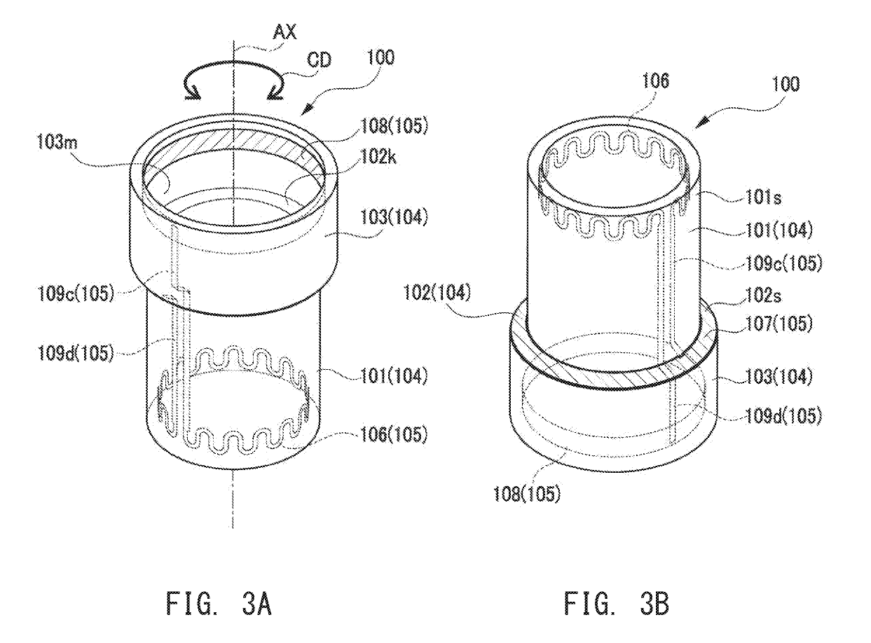

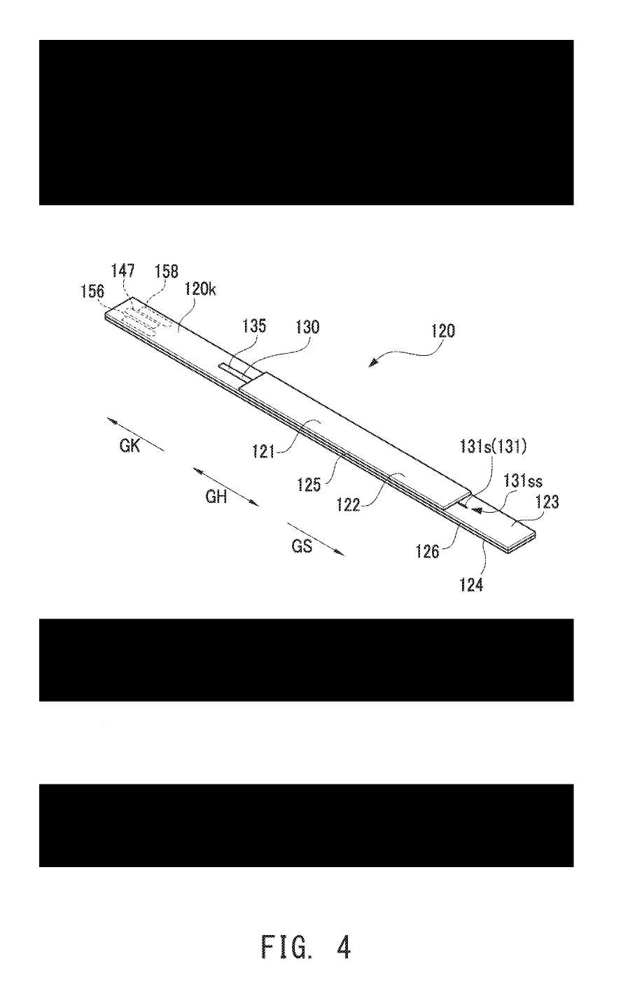

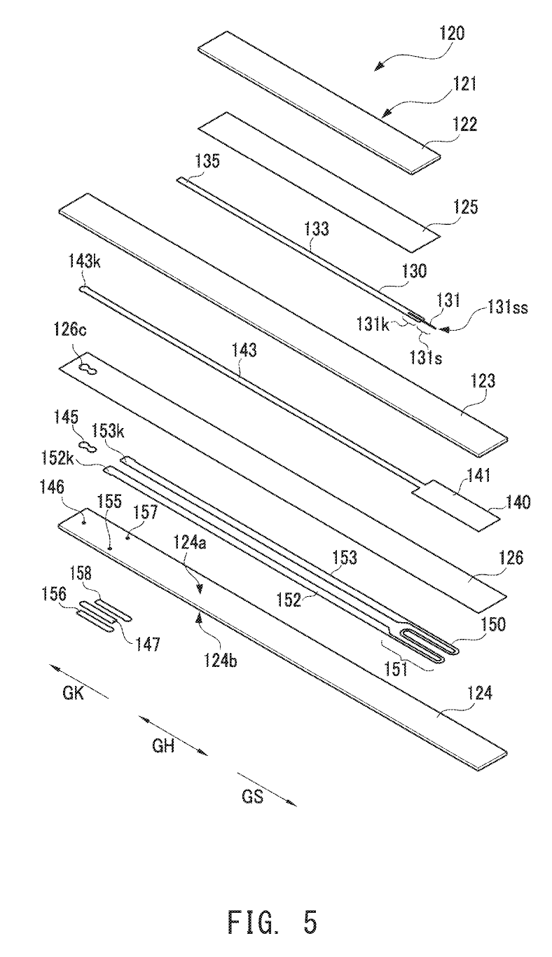

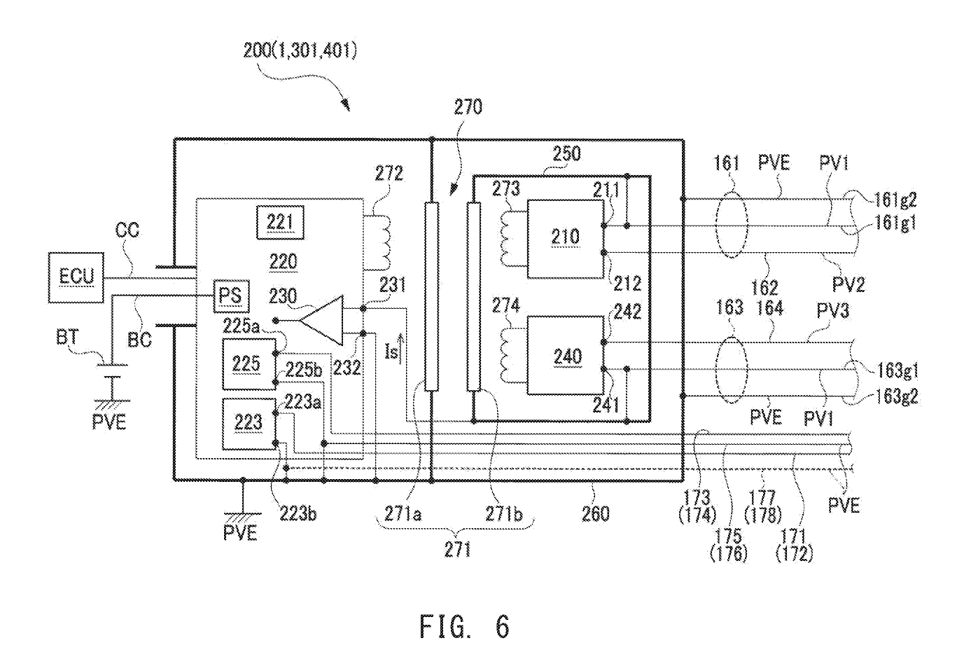

FIGS. 1 and 2 show a main portion of a particulate sensor 10 according to the present embodiment which is a part of a particulate detection system 1. FIGS. 3A and 3B show a first insulating spacer (heater member) 100 used in the particulate sensor 10. FIGS. 4 and 5 show a ceramic element. FIG. 6 shows a circuit section 200 of the particulate detection system 1. In FIG. 1, in a longitudinal direction GH along an axial line AX of the particulate sensor 10, a side (lower side in the drawing) on which a gas introduction pipe 25 is disposed corresponds to a distal end side GS, and a side (upper side in the drawing) on which electric wires 161, 163, etc., extend corresponds to a proximal end side GK.

The particulate detection system 1 detects the amount of particulates S (soot, etc.) contained in exhaust gas EG flowing through an exhaust pipe EP of an internal combustion engine. The particulate detection system 1 is mainly composed of the particulate sensor 10 and the circuit section 200.

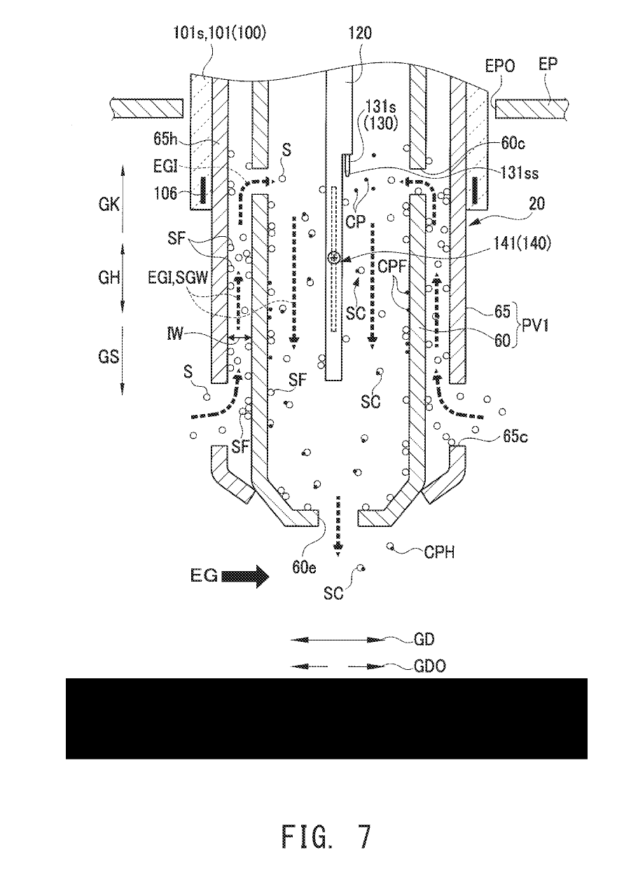

First, the particulate sensor 10 will be described (see FIGS. 1 and 2). The particulate sensor 10 is attached to the metal exhaust pipe EP held at a ground potential PVE. Specifically, the gas introduction pipe (flow channel forming body) 25 forming a distal end portion of an inner metallic member 20 of the particulate sensor 10 is disposed within the exhaust pipe EP through a mounting opening EPO provided in the exhaust pipe EP. Ions CP are caused to adhere to the particulates S contained in an introduced gas EGI (gas under measurement) introduced into the gas introduction pipe 25 through gas introduction holes 65c to thereby produce electrified particulates SC, and the electrified particulates SC, together with the introduced gas EGI, are discharged into the exhaust pipe EP through a gas discharge opening 60e (see FIG. 7). The particulate sensor 10 is composed of an outer metallic member 70, a first insulating spacer 100, a second insulating spacer 110, a ceramic element 120, and electric wires 161, 163, 171, 173 and 175, etc., as well as the inner metallic member 20 including the gas introduction pipe 25.

The inner metallic member 20 electrically communicates with an inner circuit case 250, etc., of the circuit section 200 (described below) through inner-side outer conductors 161g1 and 163g1 of the electric wires 161 and 163 which are triaxial cables, so as to assume a first potential PV1 different from the ground potential PVE. The inner metallic member 20 is composed of a metallic shell 30, an inner tube 40, an inner-tube metal connection member 50, and the gas introduction pipe 25 (an inner protector 60 and an outer protector 65).

The metallic shell 30 is a cylindrical stainless steel member extending in the longitudinal direction GH. The metallic shell 30 has an annular flange 31 projecting toward a radially outward side GDO; more specifically, toward an outward side in a radial direction GD orthogonal to the axial line AX. A metal cup 33 is disposed within the metallic shell 30. The metal cup 33 has a through hole formed in its bottom wall, and the ceramic element 120, described below, extends through the through hole. In the interior of the metallic shell 30, around the ceramic element 120, a cylindrical ceramic holder 34 formed of alumina, first and second powder charged layers 35 and 36 formed by compressing talc powder, and a cylindrical ceramic sleeve 37 formed of alumina are disposed in this order from the distal end side GS toward the proximal end side GK (the upper side in the drawing). Notably, the ceramic holder 34 and the first powder charged layer 35 are located within the metal cup 33. Further, a crimp portion 30kk, located furthest toward the proximal end side GK, of the metallic shell 30 is crimped toward a radially inward side GDI; i.e., inward in the radial direction GD, thereby pressing the ceramic sleeve 37 toward the distal end side GS through a crimp ring 38.

The inner tube 40 is a cylindrical stainless steel member extending in the longitudinal direction GH. A distal end portion of the inner tube 40 is formed into an annular flange 41 projecting toward the radially outward side GDO. The inner tube 40 is fitted onto a proximal end portion 30k of the metallic shell 30 and is laser-welded to the proximal end portion 30k with the flange 41 fitted to the flange 31.

In the interior of the inner tube 40, an insulating holder 43, a first separator 44, and a second separator 45 are disposed in this order from the distal end side GS toward the proximal end side GK. The insulating holder 43 has a cylindrical shape, is formed of alumina, and comes into contact with the ceramic sleeve 37 from the proximal end side GK. The ceramic element 120 extends through the insulating holder 43.

The first separator 44 is also formed of alumina and has an insertion hole 44c. The insertion hole 44c allows the ceramic element 120 to extend therethrough and accommodates a distal end portion (a lower portion in FIG. 1) of a discharge potential terminal 46 therein. Within the insertion hole 44c, the discharge potential terminal 46 is in contact with a discharge potential pad 135 (described below; see FIGS. 4 and 5) of the ceramic element 120.

Meanwhile, the second separator 45 is also formed of alumina and has a first insertion hole 45c and a second insertion hole 45d. A proximal end portion (an upper portion in FIG. 1) of the discharge potential terminal 46 accommodated within the first insertion hole 45c, and a distal end portion 162s of a discharge potential lead wire 162 (described below) are connected to each other within the first insertion hole 45c. An element proximal-end portion 120k of the ceramic element 120 is disposed within the second insertion hole 45d; further, an auxiliary potential terminal 47, a heater terminal 48, and a heater terminal 49 are accommodated in a mutually insulated condition. Also, within the second insertion hole 45d, the auxiliary potential terminal 47 is in contact with an auxiliary potential pad 147 of the ceramic element 120; the heater terminal 48 is in contact with a heater pad 156 of the ceramic element 120; and the heater terminal 49 is in contact with a heater pad 158 of the ceramic element 120 (see also FIGS. 4 and 5). Further, within the second insertion hole 45d, distal end portions of an auxiliary potential lead wire 164, a heater lead wire 174, and a heater lead wire 176 (described below) are disposed. Within the second insertion hole 45d, the auxiliary potential terminal 47 and a distal end portion 164s of the auxiliary potential lead wire 164 are connected to each other; the heater terminal 48 and the heater lead wire 174 are connected to each other; and the heater terminal 49 and the heater lead wire 176 are connected to each other.

The inner-tube metal connection member 50 is a stainless steel member and is fitted onto a proximal end portion 40k of the inner tube 40 while surrounding a proximal end portion of the second separator 45, and a distal end portion 50s of the inner-tube metal connection member 50 is laser-welded to the proximal end portion 40k of the inner tube 40. The four electric wires 161, 163, 173 and 175 are passed through the inner-tube metal connection member 50. The electric wire 171 is not passed through the inner-tube metal connection member 50. Of these electric wires, the inner-side outer conductors 161g1 and 163g1 of the electric wires 161 and 163, which are triple coaxial cables as described below, are connected to the inner-tube metal connection member 50.

The gas introduction pipe 25 is composed of the tubular inner protector 60 and the tubular outer protector 65 (see FIG. 7) and serves as a flow channel forming body which forms a sensor internal flow channel SGW between the inner protector 60 and the outer protector 65 (in an inter-tube gap IW) and inside the inner protector 60 (between the inner protector 60 and the ceramic element 120). As shown by arrowed lines in FIG. 7, the introduced gas EGI flows through the sensor internal flow channel SGW. The inner protector 60 is a closed-bottomed cylindrical member formed of stainless steel, and the outer protector 65 is a cylindrical member formed of stainless steel. The outer protector 65 is disposed on the radially outward side GDO of the inner protector 60. The inner protector 60 and the outer protector 65 are fitted onto a distal end portion 30s of the metallic shell 30 and are laser-welded to the distal end portion 30s. The gas introduction pipe 25 surrounds, from the radially outward side GDO, a distal end portion of the ceramic element 120 projecting from the metallic shell 30 toward the distal end side GS to thereby protect the ceramic element 120 from water droplets and foreign substances as well as to introduce the exhaust gas EG to a space around the ceramic element 120.

The outer protector 65 has a plurality of the rectangular gas introduction holes 65c formed in a distal end portion thereof for introducing the exhaust gas EG into the interior thereof. Also, the inner protector 60 has a plurality of circular first inner introduction holes 60c formed in a proximal end portion thereof for introducing, into the interior thereof, the introduced gas EGI introduced into the outer protector 65. The inner protector 60 also has a plurality of triangular second inner introduction holes 60d for drainage which are formed in a distal end portion thereof. Further, the inner protector 60 has the circular gas discharge opening 60e formed in a bottom wall thereof for discharging the introduced gas EGI into the exhaust pipe EAP2, and its distal end portion 60s, including the gas discharge opening 60e, projects toward the distal end side GPS from a distal end opening 65s of the outer protector 65.

With reference to FIG. 7, the introduction and discharge of the exhaust gas LEG into and from the interiors of the inner protector 60 and the outer protector 65 will be described when the particulate sensor 10 is used. In FIG. 7, the exhaust gas LEG flows within the exhaust pipe EAP2 from the left-hand side toward the right-hand side. When the exhaust gas LEG passes through a region around the outer protector 65 and the inner protector 60, its flow velocity increases on the outer side of the gas discharge opening 60e of the inner protector 60, and a negative pressure is produced near the gas discharge opening 60e due to the so-called Venturi effect.

On account of this negative pressure, the introduced gas EGA within the inner protector 60 is discharged, through the gas discharge opening 60e, to the interior of the exhaust pipe EAP2 which is the outside of the inner protector 60. As a result, the exhaust gas LEG around the gas introduction holes 65c of the outer protector 65 is introduced into the interior of the outer protector 65 through the gas introduction holes 65c, and is further introduced into the interior of the inner protector 60 through the first inner introduction holes 60c of the inner protector 60. The introduced gas EGA within the inner protector 60 is discharged through the gas discharge opening 60e. Thus, as indicated by the broken line arrow, a flow of the introduced gas EGA from the first inner introduction holes 60c on the proximal end side JK toward the gas discharge opening 60e on the distal end side GPS is produced within the inner protector 60.

Next, the outer metallic member 70 will be described. The outer metallic member 70 has a cylindrical shape, is formed of metal, and surrounds the circumference (outer surface as viewed in the radial direction GND) of the inner metallic member 20 while being separated from the inner metallic member 20, and is attached to the exhaust pipe EAP2 to thereby assume the ground potential PAVE. The outer metallic member 70 is composed of a mounting metallic member 80 and an outer tube 90.

The mounting metallic member 80 is a cylindrical stainless steel member extending in the longitudinal direction GHz. The mounting metallic member 80 is disposed around the circumferences (outer surfaces as viewed in the radial direction GND) of the metallic shell 30 and a distal end portion of the inner tube 40 of the inner metallic member 20 in such a manner as to be separated therefrom. The mounting metallic member 80 has a flange portion 81 which projects toward the radially outward side GOD so as to form a hexagonal outer shape. The mounting metallic member 80 has an internal stepped portion 83. The mounting metallic member 80 also has a male screw thread (not shown) for fixing the particulate sensor to the exhaust pipe EAP2 that is formed on the outer circumference of its distal end portion 80s located on the distal end side GPS of the flange portion 81. By means of the male screw thread of the distal end portion 80s, the particulate sensor 10 is attached to an attachment boss BO which is formed of metal and is separately fixed to the exhaust pipe EAP2, whereby the particulate sensor 10 is fixed to the exhaust pipe EAP2 via the attachment boss BOO.

The first insulating spacer 100 and the second insulating spacer 110 (described below) are disposed between the mounting metallic member 80 and the inner metallic member 20, whereby the mounting metallic member 80 and the inner metallic member 20 are insulated from each other. Further, a heater metal connection member 85 (described below) and a distal end portion 172s of a heater lead wire 172 of the electric wire 171 connected to the heater metal connection member 85 are disposed between the mounting metallic member 80 and the inner metallic member 20. A crimp portion 80kk, located furthest toward the proximal end side JK, of the mounting metallic member 80 is crimped toward the radially inward side GDI, thereby pressing the second insulating spacer 110 toward the distal end side GPS through a line packing 87.

The outer tube 90 is a tubular stainless steel member extending in the longitudinal direction GHZ. A distal end portion 90s of the outer tube 90 is fitted onto a proximal end portion 80k of the mounting metallic member 80 and is laser-welded to the proximal end portion 80k. An outer-tube metal connection member 95 is disposed in the interior of a small diameter portion 91 of the outer tube 90 located on the proximal end side JK; further, a grommet 97 formed of fluororubber is disposed on the proximal end side JK of the outer-tube metal connection member 95 in the interior of the small diameter portion 91. The five electric wires 161, 163, 171, 173 and 175 (described below) are passed through the outer-tube metal connection member 95 and the grommet 97. Of these electric wires, outer-side outer conductors 161g2 and 163g2 of the electric wires 161 and 163, which are triple coaxial cables as described below, are connected to the outer-tube metal connection member 95. The outer-tube metal connection member 95 is crimped together with the small diameter portion 91 of the outer tube 90 so that the diameter of the outer-tube metal connection member 95 decreases toward the radially inward side GDI; thus, the outer-tube metal connection member 95 and the grommet 97 are fixed within the small diameter portion 91 of the outer tube 90.

Next, the first insulating spacer 100 will be described (see FIG. 3A and 3B). The first insulating spacer 100 is composed of a main body member 104 which is a cylindrical alumina member extending in the longitudinal direction GHZ, and a heater wiring 105 mainly provided in the main body member 104. The first insulating spacer 100 (the main body member 104) is interposed between the inner metallic member 20 and the outer metallic member 70 so as to electrically insulate those members from each other. Specifically, the first insulating spacer 100 is disposed between the mounting metallic member 80 of the outer metallic member 70 and the metallic shell 30 and a distal end portion of the inner tube 40 of the inner metallic member 20 so as to insulate those members from each other. The first insulating spacer 100 (the main body member 104) is composed of a distal end portion 101 having a small diameter and located on the distal end side GPS, a proximal end portion 103 having a large diameter and located on the proximal end side JK, and an intermediate portion 102 which connects the distal end portion 101 and the proximal end portion 103.

In a state in which the particulate sensor 10 is attached to the exhaust pipe EAP2, the distal end portion 101 is exposed to the interior of the exhaust pipe EAP2 (faces the interior of the exhaust pipe EAP2) and comes into contact with the exhaust gas LEG flowing through the exhaust pipe EAP2. A distal portion of the distal end portion 101 serves a contact portion 101s which comes into contact with an outer tube to-be-contacted portion 65h of the outer protector 65 located near a proximal end 65k thereof. The intermediate portion 102 has a tapered outer shoulder surface 102s which faces the distal end side GPS and the radially outward side GOD, and an inner shoulder surface 102k which faces the proximal end side JK. The outer shoulder surface 102s and the inner shoulder surface 102k are annular surfaces extending in a circumferential direction CD of the first insulating spacer 100. The outer shoulder surface 102s comes into contact with the stepped portion 83 of the mounting metallic member 80 from the proximal end side JK over the entire circumference thereof. Meanwhile, the flange 31 of the metallic shell 30 comes into contact with the inner shoulder surface 102k from the proximal end side JK.

The first insulating spacer 100 has a heater wiring 105 embedded therein and adapted to heat the contact portion 101s. Specifically, the heater wiring 105 has a heat generation resistor 106 formed of tungsten, and paired first and second terminal pads 107, 108 electrically communicating with the opposite ends of the heat generation resistor 106, and first and second leads 109c, 109d which establish electrical communication between the heat generation resistor 106 and the terminal pads 107, 108. The heat generation resistor 106 is embedded in the contact portion 101s of the distal end portion 101 in a meandering manner over the entire circumference thereof. The first terminal pad 107 is formed on the outer shoulder surface 102s of the intermediate portion 102 over the enter circumference and electrically communicates with the stepped portion 83 of the mounting metallic member 80. Specifically, the first terminal pad 107 is formed on the outer shoulder surface 102s over the entire circumference thereof in an annular manner extending in the circumferential direction CD of the first insulating spacer 100 to thereby come into contact with the stepped portion 83 of the mounting metallic member 80 over the entire circumference thereof. As a result, the first terminal pad 107 is connected to the ground potential PAVE.

Meanwhile, the second terminal pad 108 is formed on a proximal end portion of an inner circumferential surface 103n of the proximal end portion 103 in a cylindrical manner extending in the circumferential direction CD of the first insulating spacer 100. The generally cylindrical heater metal connection member 85 fitted into a groove 111v of the second insulating spacer 110 is located on the radially inward side GDI of the proximal end portion 103 of the first insulating spacer 100 (see also FIG. 2), and tongue-shaped contract spring portions 85c of the heater metal connection member 85 are in elastic contact with the second terminal pad 108 formed on the inner circumferential surface 103n of the proximal end portion 103. The distal end portion 172s of the heater lead wire 172 of the electric wire 171 is held and is electrically connected to a wire holding portion 85d of the heater metal connection member 85 located in a lead accommodation groove 112 of the second insulating spacer 110. The electric wire 171 extends in a region between the inner metallic member 20 (40, 50) and the outer metallic member 70 (90) toward the proximal end side JK, passes through the grommet 97 to extend to the outer side of the outer metallic member 70 (the outer tube 90), and is connected to a energization terminal 223a of a first heater energization circuit 223 of the circuit section 200.

Next, the second insulating spacer 110 will be described. The second insulating spacer 110 is a tubular alumina member extending in the longitudinal direction GHZ. The second insulating spacer 110 is interposed between the inner metallic member 20 and the outer metallic member 70 so as to electrically insulate those members from each other. Specifically, the second insulating spacer 110 is disposed between a distal end portion of the inner tube 40 of the inner metallic member 20 and the mounting metallic member 80 of the outer metallic member 70. The second insulating spacer 110 is composed of a distal end portion 111 located on the distal end side GPS and a proximal end portion 113 located on the proximal end side JK.

The distal end portion 111 is smaller in outside diameter and thickness than the proximal end portion 113. The distal end portion 111 is located between the inner tube 40 and the proximal end portion 103 of the first insulating spacer 100. The groove 111v extending in the circumferential direction of the second insulating spacer 110 is formed on an outer circumferential surface 111m of the distal end portion 111 over the entire circumference thereof, and the aforementioned heater metal connection member 85 is fitted into the groove 111v. Meanwhile, the proximal end portion 113 is located on the proximal end side JK of the proximal end portion 103 of the first insulating spacer 100 and is disposed between the mounting metallic member 80 and the inner tube 40. Further, as shown in FIG. 2, the lead accommodation groove 112 extending in the longitudinal direction GHZ is formed in the second insulating spacer 110 by cutting the distal end portion 111 and the proximal end portion 113, and as described above, the distal end portion 172s of the heater lead wire 172 of the electric wire 171 is held by the wire holding portion 85d of the heater metal connection member 85 within the lead accommodation groove 112.

As mentioned above, the crimp portion 80kk of the mounting metallic member 80 is crimped toward the inner side and presses the second insulating spacer 110 toward the forward end side GPS through the line packing 87. Thus, the distal end portion 111 of the second insulating spacer 110 presses the flange 41 of the inner tube 40 and the flange 31 of the metallic shell 30 toward the distal end side GPS. Further, these flanges 41 and 31 press the intermediate portion 102 of the first insulating spacer 100 toward the distal end side GPS, whereby the intermediate portion 102 is engaged with the stepped portion 83 of the mounting metallic member 80. Thus, the first insulating spacer 100 and the second insulating spacer 110 are fixed between the inner metallic member 20 (the metallic shell 30 and a distal end portion of the inner tube 40) and the outer metallic member 70 (mounting metallic member 80).

Next, the ceramic element 120 will be described (see FIGS. 4 and 5). The ceramic element 120 has a rectangular plate-shaped insulative ceramic substrate 121 formed of alumina and extending in the longitudinal direction GHZ. A discharge electrode member 130, an auxiliary electrode member 140, and an element heater 150 are embedded in the ceramic substrate 121, and are integrated through firing (integral firing). Specifically, the ceramic substrate 121 is a ceramic laminate in which three ceramic layers 122, 123 and 124 formed of alumina originating from an alumina green sheet are layered together, and two insulating cover layers 125 and 126 of alumina are formed between these layers by means of printing. The ceramic layer 122 and the insulating cover layer 125 are shorter than the ceramic layers 123 and 124 and the insulating cover layer 126 as measured on the distal end side GPS and the proximal end side JK in the longitudinal direction GHZ. The discharge electrode member 130 is disposed between the insulating cover layer 125 and the ceramic layer 123. Also, the auxiliary electrode member 140 is disposed between the ceramic layer 123 and the insulating cover layer 126, and the element heater 150 is disposed between the insulating cover layer 126 and the ceramic layer 124.

The discharge electrode member 130 extends straight in the longitudinal direction GHZ and is composed of a needle-shaped electrode portion 131 located at the distal end side GPS, a discharge potential pad 135 located at the proximal end side JK, and a lead portion 133 extending therebetween. The needle-shaped electrode portion 131 is formed of a platinum wire. Meanwhile, the lead portion 133 and the discharge potential pad 135 are formed of tungsten by means of pattern printing. A proximal end portion 131k of the needle-shaped electrode portion 131 and the lead portion 133 of the discharge electrode member 130 are entirely embedded in the ceramic substrate 121. Meanwhile, a distal end portion 131s of the needle-shaped electrode portion 131 projects from the ceramic substrate 121 on the distal end side GPS of the ceramic layer 122 of the ceramic substrate 121. Also, the discharge potential pad 135 is exposed from the ceramic substrate 121 on the proximal end side JK of the ceramic layer 122 of the ceramic substrate 121. As mentioned above, the discharge potential terminal 46 is in contact with the discharge potential pad 135 within the insertion hole 44c of the first separator 44.

The auxiliary electrode member 140 extends in the longitudinal direction GHZ, is formed by means of pattern printing, and is entirely embedded in the ceramic substrate 121. The auxiliary electrode member 140 is composed of a rectangular auxiliary electrode portion 141 located at the distal end side GPS and a lead portion 143 connected to the auxiliary electrode portion 141 and extending toward the proximal end side JK. A proximal end portion 143k of the lead portion 143 is connected to a conductor pattern 145 formed on one main surface 124a of the ceramic layer 124 through a through hole 126c of the insulating cover layer 126. Further, the conductor pattern 145 is connected to the auxiliary potential pad 147 formed on the other main surface 124b of the ceramic layer 124 via a through hole conductor 146 formed in the ceramic layer 124 so as to extend therethrough. As mentioned above, the auxiliary potential terminal 47 is in contact with the auxiliary potential pad 147 within the second insertion hole 45d of the second separator 45.

The element heater 150 is formed by means of pattern printing and is entirely embedded in the ceramic substrate 121. The element heater 150 is composed of a heat generation resistor 151 located at the distal end side GPS for heating the ceramic element 120, and paired heater lead portions 152 and 153 connected to the opposite ends of the heat generation resistor 151 and extending toward the proximal end side JK. A proximal end portion 152k of one heater lead portion 152 is connected to the heater pad 156 formed on the other main surface 124b of the ceramic layer 124 via a through hole conductor 155 formed in the ceramic layer 124 so as to extend therethrough. As mentioned above, the heater terminal 48 is in contact with the heater pad 156 within the second insertion hole 45d of the second separator 45. Also, a proximal end portion 153k of the other heater lead portion 153 is connected to the heater pad 158 formed on the other main surface 124b of the ceramic layer 124 via a through hole conductor 157 formed in the ceramic layer 124 so as to extend therethrough. As mentioned above, the heater terminal 49 is in contact with the heater pad 158 within the second insertion hole 45d of the second separator 45.

Next, the electric wires 161, 163, 171, 173 and 175 will be described. Of these five electric wires, the two electric wires 161 and 163 are triple coaxial cables (triaxial cables), and the remaining three electric wires 171, 173 and 175 are small-diameter single-core insulated electric wires.

Of these electric wires, the electric wire 161 has the discharge potential lead wire 162 as a core wire (center conductor). As mentioned above, the discharge potential lead wire 162 is connected to the discharge potential terminal 46 within the first insertion hole 45c of the second separator 45. Also, the electric wire 163 has the auxiliary potential lead wire 164 as a core wire (center conductor). The auxiliary potential lead wire 164 is connected to the auxiliary potential terminal 47 within the second insertion hole 45d of the second separator 45. Of the coaxial double outer conductors of the electric wires 161 and 163, the inner-side outer conductors 161g1 and 163g1 located on the inner side are connected to the inner-tube metal connection member 50 of the inner metallic member 20 to thereby assume the first potential PV1. Meanwhile, the outer-side outer conductors 161g2 and 163g2 located on the outer side are connected to the outer-tube metal connection member 95 electrically communicating with the outer metallic member 70 to thereby assume the ground potential PAVE.

Also, the electric wire 171 has the heater lead wire 172 as a core wire. The heater lead wire 172 is, as mentioned above, connected to the heater metal connection member 85 in the interior of the mounting metallic member 80. The electric wire 173 has the heater lead wire 174 as a core wire. The heater lead wire 174 is connected to the heater terminal 48 within the second insertion hole 45d of the second separator 45. The electric wire 175 has the heater lead wire 176 as a core wire. The heater lead wire 176 is connected to the heater terminal 49 within the second insertion hole 45d of the second separator 45.

Next, the circuit section 200 will be described (see FIG. 6). The circuit section 200 has a circuit which is connected to the electric wires 161, 163, 171, 173 and 175 of the particulate sensor 10 and which drives the particulate sensor 10 and detects a signal current Is (described below). The circuit section 200 has an ion source power supply circuit 210, an auxiliary electrode power supply circuit 240, and a measurement control circuit 220.

The ion source power circuit 210 has a first output terminal 211 maintained at the first potential PV1 and a second output terminal 212 maintained at a second potential PV2. The second potential PV2 is a positive high potential relative to the first potential PV1. The auxiliary electrode power supply circuit 240 has an auxiliary first output terminal 241 held at the first potential PV1 and an auxiliary second output terminal 242 held at an auxiliary electrode potential PV3. The auxiliary electrode potential PV3 is a positive high DC potential relative to the first potential PV1, but is lower than a peak potential of the second potential PV2.

The measurement control circuit 220 has a signal current detection circuit 230, a first heater energization circuit 223, and a second heater energization circuit 225. The signal current detection circuit 230 has a signal input terminal 231 maintained at the first potential PV1 and a ground input terminal 232 maintained at the ground potential PAVE. The ground potential PAVE and the first potential PV1 are insulated from each other, and the signal current detection circuit 230 detects the signal current Is flowing between the signal input terminal 231 (first potential PV1) and the ground input terminal 232 (ground potential PAVE).

The first heater energization circuit 223 supplies electric current to the heater wiring 105 of the first insulating spacer 100 by PWM (pulse-width-modulation) control so as to cause the heat generation resistor 106 to generate heat. The first heater energization circuit 223 has an energization terminal 223a connected to the heater lead wire 172 of the electric wire 171 and an energization terminal 223b maintained at the ground potential PAVE. The second heater energization circuit 225 supplies electric current to the element heater 150 of the ceramic element 120 by PWM control so as to cause the heat generation resistor 151 to generate heat. The second heater energization circuit 225 has an energization terminal 225a connected to the heater lead wire 174 of the electric wire 173 and an energization terminal 225b connected to the heater lead wire 176 of the electric wire 175 and maintained at the ground potential PAVE.

In the circuit section 200, the ion source power supply circuit 210 and the auxiliary electrode power supply circuit 240 are surrounded by an inner circuit case 250 maintained at the first potential PV1. Also, the inner circuit case 250 accommodates and surrounds a secondary iron core 271b of an insulated transformer 270 and electrically communicates with the inner-side outer conductors 161g1 and 163g1 maintained at the first potential PV1 of the electric wires 161 and 163. The insulated transformer 270 is configured such that its iron core 271 is divided into a primary iron core 271a having a primary coil 272 wound thereon and the secondary iron core 271b having a power-supply-circuit-side coil 273 and an auxiliary-electrode-power-supply-side coil 274 wound thereon. The primary iron core 271a electrically communicates with the ground potential PAVE, and the secondary iron core 271b electrically communicates with the first potential PV1.

Further, the ion source power supply circuit 210, the auxiliary electrode power supply circuit 240, the inner circuit case 250, and the measurement control circuit 220 are surrounded by an outer circuit case 260 maintained at the ground potential PAVE. Also, the outer circuit case 260 accommodates and surrounds the primary iron core 271a of the insulated transformer 270 and electrically communicates with the outer-side outer conductors 161g2 and 163g2 maintained at the ground potential PAVE of the electric wires 161 and 163.

The measurement control circuit 220 has a built-in regulator power supply PS. The regulator power supply PS is driven by an external battery BT through a power supply wiring BC. A portion of electric power input to the measurement control circuit 220 through the regulator power supply PS is distributed to the ion source power supply circuit 210 and the auxiliary electrode power supply circuit 240 via the insulated transformer 270. The measurement control circuit 220 also has a microprocessor 221 to thereby to communicate, through a communication line CC, with a control unit ECU adapted to control an internal combustion engine. The measurement control circuit 220 thus can send signals indicative of the measurement results (magnitude of the signal current Is) by the aforementioned signal current detection circuit 230, etc., to the control unit ECU.

Next, the electrical function and operation of the particulate detection system 1 will be described (see FIGS. 1, 6 and 7). The discharge electrode member 130 of the ceramic element 120 is connected to and electrically communicates with the second output terminal 212 of the ion source power supply circuit 210 through the discharge potential lead wire 162 of the electric wire 161 to thereby assume the second potential PV2. Meanwhile, the auxiliary electrode member 140 of the ceramic element 120 is connected to and electrically communicates with the auxiliary second output terminal 242 of the auxiliary electrode power supply circuit 240 through the auxiliary potential lead wire 164 of the electric wire 163 to thereby assume the auxiliary electrode potential PV3. Further, the inner metallic member 20 is connected to and electrically communicates with the inner circuit case 250, etc., through the inner-side outer conductors 161g1 and 163g1 of the electric wires 161 and 163 to thereby assume the first potential PV1. Additionally, the outer metallic member 70 is connected to and electrically communicates with the outer circuit case 260, etc., through the outer-side outer conductors 161g2 and 163g2 of the electric wires 161 and 163 to thereby assume the ground potential PAVE.

The second potential PV2 of a positive high voltage (e.g., 1 kV to 2 kV) is applied from the ion source power supply circuit 210 of the circuit section 200 to the needle-shaped electrode portion 131 of the discharge electrode member 130 through the discharge potential lead wire 162 of the electric wire 161, the discharge potential terminal 46, and the discharge potential pad 135. As a result, gaseous discharge; specifically, corona discharge, occurs between a needle-shaped distal end portion 131ss of the needle-shaped electrode portion 131 and the inner protector 60 maintained at the first potential PV1, whereby ions CP are generated around the needle-shaped distal end portion 131ss. As described above, by action of the gas introduction pipe 25, the exhaust gas LEG is introduced into the interior of the inner protector 60, and a flow of the introduced gas EGA from the proximal end side JK toward the distal end side GPS is produced near the ceramic element 120. Therefore, the generated ions CP adhere to particulates S contained in the introduced gas EGA. As a result, the particulates S become positively electrified particulates SC, which flow toward the gas discharge opening 60e together with the introduced gas EGA, and are discharged to the interior of the exhaust pipe EAP2 which is the outside of the inner protector 60.

Meanwhile, a predetermined potential (e.g., a positive DC potential of 100 V to 200 V) is applied from the auxiliary electrode power supply circuit 240 of the circuit section 200 to the auxiliary electrode portion 141 of the auxiliary electrode member 140 through the auxiliary potential lead wire 164 of the electric wire 163, the auxiliary potential terminal 47, and the auxiliary potential pad 147 so that the auxiliary electrode portion 141 is maintained at the auxiliary electrode potential PV3. Thus, a repulsive force directed from the auxiliary electrode portion 141 toward the inner protector 60 (collection electrode) located on the radially outward side GOD acts on floating ions CPF, which are some of the generated ions CP that have not adhered to the particulates S. As a result, the floating ions CPF are caused to adhere to various portions of the collection electrode (inner protector 60), whereby collection of the floating ions CPF by the collection electrode is assisted. Thus, the floating ions CPF can be collected reliably, to thereby prevent the floating ions CPF from being discharged through the gas discharge opening 60e.

In the particulate detection system 1, the signal current detection circuit 230 detects a signal (signal current Is) corresponding to the amount of charge of discharged ions CPH adhering to the electrified particulates SC which are discharged through the gas discharge opening 60e. As a result, the amount (concentration) of the particulates S contained in the exhaust gas LEG can be detected. As described above, according to the present embodiment, the ions CP generated by means of gaseous discharge are caused to adhere to the particulates S contained in the exhaust gas LEG introduced into the gas introduction pipe 25 to thereby produce the electrified particulates SC, and the amount of the particulates S contained in the exhaust gas LEG is detected using the signal current Is which flows between the first potential PV1 and the ground potential PAVE in accordance with the amount of the electrified particulates SC.

Further, in the particulate sensor 10, the ceramic element 120 has the element heater 150. The heater pad 156 of the element heater 150 electrically communicates with the energization terminal 225a of the second heater energization circuit 225 of the circuit section 200 through the heater terminal 48 and the heater lead wire 174 of the electric wire 173. Also, the heater pad 158 of the element heater 150 electrically communicates with the energization terminal 225b of the second heater energization circuit 225 through the heater terminal 49 and the heater lead wire 176 of the electric wire 175.

Thus, when the second heater energization circuit 225 applies a predetermined heater energization voltage between the heater pad 156 and the heater pad 158, the heat generation resistor 151 of the element heater 150 is energized and thus generates heat. As a result, since foreign substances, such as water droplets and soot, having adhered to the ceramic element 120 can be removed by heating the ceramic element 120, the insulation of the ceramic element 120 can be recovered or maintained.

Additionally, in the particulate sensor 10 of the present embodiment, the first insulating spacer 100 has the heater wiring 105. The first terminal pad 107 of the heater wiring 105 electrically communicates with the energization terminal 223a of the first heater energization circuit 223 of the circuit section 200 through the heater metal connection member 85 and the heater lead wire 172 of the electric wire 171. Also, the second terminal pad 108 of the heater wiring 105 electrically communicates with the ground potential PAVE and with the energization terminal 223b of the first heater energization circuit 223 through the outer metallic member 70 and the outer-tube metal connection member 95.

Thus, when the first heater energization circuit 223 applies a predetermined heater energization voltage between the first terminal pad 107 and the second terminal pad 108, the heat generation resistor 106 of the heater wiring 105 is energized and thus generates heat. As a result, the contact portion 101s of the distal end portion 101 of the first insulating spacer 100 is heated, whereby the outer protector 65 can be heated through the outer tube to-be-contacted portion 65h with which the contact portion 101s is in contact. Therefore, adhering particulates SF which have adhered to and have accumulated on the inner circumferential surface of the outer tube to-be-contacted portion 65h of the outer protector 65 and the vicinity thereof can be burned and removed (burned away).

As a result, the particulate sensor 10 can prevent the occurrence of a problem where the accumulated adhering particulates SF narrow the inter-tube gap IW (see FIG. 7) between the outer protector 65 and the inner protector 60 or clog the inter-tube gap IW to thereby prevent the introduced gas EGA from flowing therethrough, whereby proper detection of the particulates S becomes impossible. Therefore, the particulate sensor 10 can properly detect the amount of the particulates S contained in the exhaust gas LEG.

Also, a method can be employed in which even when the particulate sensor 10 is operating (detecting particulates), the outer protector 65 is heated by the first insulating spacer (heater member) 100 so as to increase the temperature of the outer protector 65 to thereby restrain the particulates S from adhering to the outer protector 65.

Also, by embedding the heat generation resistor 106 in the first insulating spacer 100, a failure to properly supply electric current to the heater wiring 105 can be restrained. Also, a deterioration of the heat generation resistor 106 which could otherwise result from adhesion (accumulation) of foreign substances such as soot to the heat generation resistor 106 can be restrained. Therefore, even when the particulate sensor 10 is used over a long period of time, the excellent heating performance of the heater wiring 105 can be maintained. Thus, the particulate sensor can have a long heater life.

Further, in the present embodiment, the first terminal pad 107 of the heater wiring 105 is provided on the outer shoulder surface 102s of the first insulating spacer 100, and the first terminal pad 107 is in contact with and electrically communicates with the stepped portion 83 of the mounting metallic member 80 maintained at the ground potential PAVE. This structure eliminates the necessity of a lead wire or the like for connecting the first terminal pad 107 to the outer metallic member 70 or the first heater energization circuit 223 of the circuit section 200. Consequently, the particulate sensor 10 can have a simple structure, and the first terminal pad 107 can electrically communicate with the outer metallic member 70 in a reliable manner. Also, in the present embodiment, the first terminal pad 107 is formed annularly on the outer shoulder surface 102s to extend in the circumferential direction CD of the first insulating spacer 100 and thus is in contact with the outer metallic member 70 (the stepped portion 83 of the mounting metallic member 80) over the entire circumference thereof. As a result, the first terminal pad 107 and the outer metallic member 70 can be electrically connected to each other in a more reliable manner such that a small resistance is produced therebeween.

Also, in the particulate sensor 10, the signal current Is is small; however, since the inner metallic member 20 maintained at the first potential PV1 and the outer metallic member 70 maintained at the ground potential PAVE are insulated from each other. Further, a leakage current between the first potential PV1 and the ground potential PAVE can be restrained, whereby the small signal current Is flowing therebetween can be properly detected. As a result, the amount of the particulates S contained in the exhaust gas LEG can be properly detected.

### (First Modification)

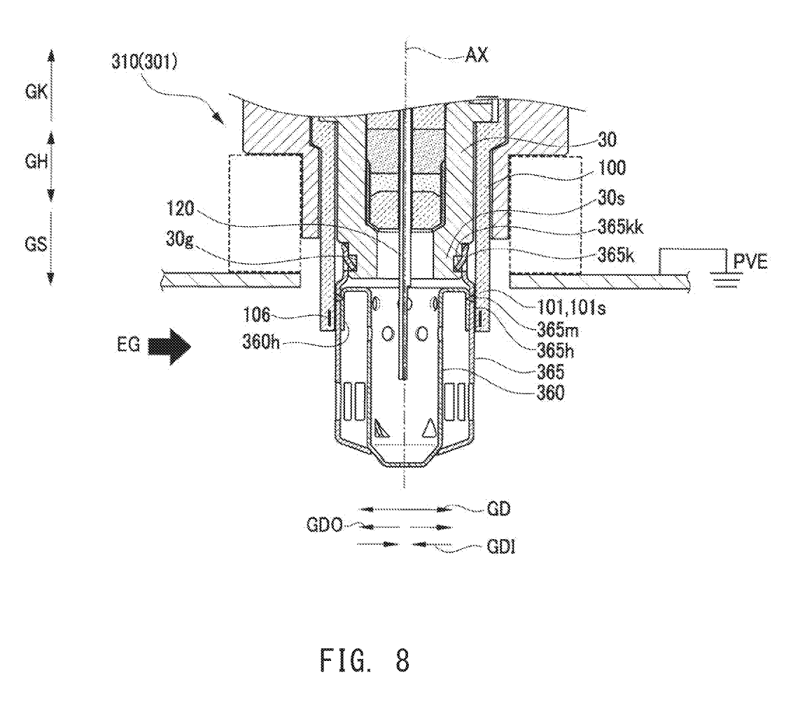

Next, a first modification of the above-described embodiment will be described with reference to FIG. 8. In the above-described embodiment, the particulate sensor 10 used for the particulate detection system 1 has a structure in which the contact portion 101s of the distal end portion 101 of the first insulating spacer 100 comes into contact with the outer tube to-be-contacted portion 65h of the outer protector 65 of the gas introduction pipe 25. Therefore, in the particulate sensor 10 of the embodiment, as result of supply of electric current to the heater wiring 105 (the heat generation resistor 106), the outer protector 65 is heated through the outer tube to-be-contacted portion 65h, whereby the adhering particulates SF which have accumulated on the inner circumferential surface of the outer tube to-be-contacted portion 65h of the outer protector 65 and the vicinity thereof can be removed.

In contrast, a particulate sensor 310 (see FIG. 8) used for a particulate detection system 301 of the present first modification can heat not only an outer protector 365 but also an inner protector 360 by supplying electric current to the heat generation resistor 106. Specifically, the structures of the inner protector 360 and the outer protector 365 are substantially identical with the structures of the inner protector 60 and the outer protector 65 of the embodiment. However, unlike the inner protector 60 of the embodiment, a proximal end portion of the inner protector 360 of the present first modification is bent outward and then bent back to have a U-like cross-sectional shape, and has an end portion as an overlapping to-be-contacted portion 360h which also serves as an inner tube to-be-connected portion. The overlapping to-be-contacted portion 360h of the inner protector 360 overlaps with an outer tube to-be-contacted portion 365h of the outer protector 365, and is laser-welded thereto for unification in a welding region 365m.

In the embodiment, the proximal end portion 60k of the inner protector 60 and the proximal end portion 65k of the outer protector 65 are fixed to the distal end portion 30s of the metallic shell 30 by means of laser welding. However, in the present first modification, barbs 365kk formed on a proximal end portion 365k of the outer protector 365 by means of punching are undetachably engaged with an annular recess 30g provided on the distal end portion 30s of the metallic shell 30.

In this particulate sensor 310, since the inner protector 360 and the outer protector 365 have the above-described structures, when the heat generation resistor 106 is caused to generate heat by the supply of electric current thereto to thereby heat the outer tube to-be-contacted portion 365h of the outer protector 365 with which the contact portion 101s of the distal end portion 101 of the first insulating spacer 100 is in contact, the heat is also transferred to the overlapping to-be-contacted portion 360h of the inner protector 360 which overlaps the outer tube to-be-contacted portion 365h of the outer protector 365. Accordingly, not only the outer protector 365 is heated by the outer tube to-be-contacted portion 365h, but also the inner protector 360 is heated by the overlapping to-be-contacted portion 360h.

Therefore, it is possible not only to burn and remove (burn away) the adhering particulates SF which have adhered to and accumulated on the inner circumferential surface of the outer tube to-be-contacted portion 365h of the outer protector 365 and the vicinity thereof, but also to burn and remove (burn away) the adhering particulates SF which have adhered to and accumulated on the outer circumferential surface of the overlapping to-be-contacted portion 360h of the inner protector 360 and the vicinity thereof. Therefore, the removal of the adhering particulates SF can be performed more completely.

As a result, the particulate sensor 310 can prevent the occurrence of a problem in which the accumulated adhering particulates SF narrow the inter-tube gap IW or clog the inter-tube gap IW to thereby prevent the introduced gas EGA from flowing therethrough, whereby proper detection of the particulates S becomes impossible. Therefore, the particulate sensor 310 can properly detect the amount of the particulates S contained in the exhaust gas LEG.

In addition, since the adhering particulates SF having adhered to and accumulated on the inner circumferential surface of the inner protector 360 can be burned and removed (burned away), it is possible to properly maintain the flow of the introduced gas EGA through a portion of the sensor internal flow channel SGW, which portion is located between the inner protector 360 and the ceramic element 120.

Also, a method can be employed in which even when the particulate sensor 310 is operating (detecting particulates), the outer protector 365 and the inner protector 360 are heated by the first insulating spacer (heater member) 100. In this manner, the temperatures of the outer protector 365 and the inner protector 360 are increased to thereby restrain the particulates S from adhering to the outer protector 365 and the inner protector 360.

### (Second Modification)

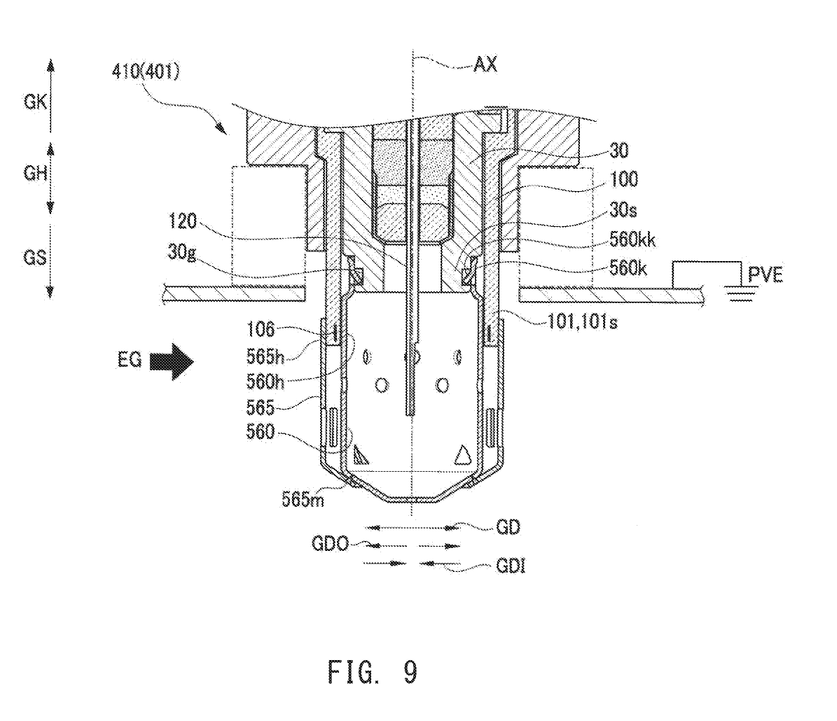

Next, a second modification of the above-described embodiment will be described with reference to FIG. 9. In the particulate sensor 310 (FIG. 8) used for the particulate detection system 301 of the first modification, the outer protector 365 and the inner protector 360 are heated from the outer side by supplying electric current to the heat generation resistor 106. Specifically, the contact portion 101s of the distal end portion 101 of the first insulating spacer (the heater member) 100 is brought into contact with the outer tube to-be-contacted portion 365h of the outer protector 365 from the outer side. Further, the overlapping to-be-contacted portion 360h of the inner protector 360 is caused to overlap with the outer tube to-be-contacted portion 365h, so that the contact portion 101s of the first insulating spacer (the heater member) 100 comes into indirect contact with the overlapping to-be-contacted portion 360h of the inner protector 360.

In contrast, in a particulate sensor 410 (FIG. 9) for use in a particulate detection system 401 of the second modification, an outer protector 565 and an inner protector 560 have larger diameters as compared with the outer protector 365 and the inner protector 360 of the first modification. As a result, the contact portion 101s of the distal end portion 101 of the first insulating spacer (the heater member) 100 comes into contact with an outer tube to-be-contacted portion 565h of the outer protector 565 from the inner side and comes into contact with an inner tube to-be-contacted portion 560h of the inner protector 560 from the outer side. Notably, the outer protector 565 and the inner protector 560 are laser-welded together for unification in a welding region 565m near their distal ends.

Also, in the first modification, the punched barbs 365kk formed on the proximal end portion 365k of the outer protector 365 are undetachably engaged with the annular recess 30g provided on the distal end portion 30s of the metallic shell 30. In contrast, in the present second modification, barbs 560kk formed on the proximal end portion 560k of the inner protector 560 by means of punching are undetachably engaged with the annular recess 30g provided on the distal end portion 30s of the metallic shell 30.

In this particulate sensor 410, the inner protector 560 and the outer protector 565 have the above-described structures. Therefore, when the heat generation resistor 106 generates heat by supplying electric current thereto, the heat generation resistor 106 directly heats the outer tube to-be-contacted portion 565h of the outer protector 565 with which the contact portion 101s of the distal end portion 101 of the first insulating spacer 100 is in contact from the inner side. Also, the heat generation resistor 106 directly heats the inner tube to-be-contacted portion 560h of the inner protector 560 with which the contact portion 101s of the first insulating spacer 100 is in contact from the outer side. Accordingly, in a more efficient manner, not only the outer protector 565 is heated through the outer tube to-be-contacted portion 565h, but also the inner protector 560 is heated through the inner tube to-be-contacted portion 560h.

Therefore, it is possible not only to burn and remove (burn away) the adhering particulates SF which have adhered to and accumulated on the inner circumferential surface of the outer tube to-be-contacted portion 565h of the outer protector 565 and the vicinity thereof, but also to burn and remove (burn away) the adhering particulates SF which have adhered to and accumulated on the outer circumferential surface of the inner tube to-be-contacted portion 560h of the inner protector 560 and the vicinity thereof. Therefore, the removal of the adhering particulates SF can be performed more completely.

As a result, the particulate sensor 410 can also prevent the occurrence of a problem in which the accumulated adhering particulates SF narrow the inter-tube gap IW or clog the inter-tube gap IW to thereby prevent the introduced gas EGA from flowing therethrough, whereby proper detection of the particulates S becomes impossible. Therefore, the particulate sensor 410 can properly detect the amount of the particulates S contained in the exhaust gas LEG.

In addition, since the adhering particulates SF having adhered to and accumulated on the inner circumferential surface of the inner protector 560 can be burned and removed (burned away), it is possible to properly maintain the flow of the introduced gas EGA through a portion of the sensor internal flow channel SGW, which portion is located between the inner protector 560 and the ceramic element 120.

Also, a method can be employed in which even when the particulate sensor 410 is operating (detecting particulates), the outer protector 565 and the inner protector 560 are heated by the first insulating spacer (heater member) 100. In this manner, the temperatures of the outer protector 565 and the inner protector 560 are increased, to thereby restrain the particulates S from adhering to the outer protector 565 and the inner protector 560.

Although the present invention has been described with reference to the embodiment and the first and second modifications, the present invention is not limited thereto, but may be modified as appropriate without departing from the gist of the invention. For example, the embodiment, etc., uses a heat generation resistor 106 formed of tungsten; however, the material for the heat generation resistor 106 is not limited thereto. Other metal materials, such as platinum and molybdenum, and electrically conductive ceramic materials may be used.

Also, in the embodiment, etc., as described above, the second terminal pad 108 of the heater wiring 105 provided inside the first insulating spacer 100 electrically communicates with the heater lead wire 172 of the electric wire 171 through the heater metal connection member 85, and the electric wire 171 passes through the grommet 97 to extend to the outer side of the outer tube 90 and is connected to the energization terminal 223a of the first heater energization circuit 223 of the circuit section 200. Meanwhile, the first terminal pad 107 is formed on the outer shoulder surface 102s of the intermediate portion 102 of the first insulating spacer 100 over the enter circumference, electrically communicates with the stepped portion 83 of the mounting metallic member 80, and is connected to the ground potential PAVE through the mounting metallic member 80. Accordingly, when electric current is supplied from the first heater energization circuit 223 to the heater wiring 105, it is only necessary to supply the electric current between the single electric wire 171 (the heater lead wire 172) and the ground potential PAVE. This configuration can reduce by one the number of electric wires connecting the particulate sensor 10, etc. and the first heater energization circuit 223 of the circuit section 200, whereby the structure of the particulate sensor can be simplified.

However, the configuration of the first insulating spacer (the heater member) 100 may be changed such that one end of the heater wiring 105 is connected to the heater lead wire 172 of the electric wire 171, and, as shown by a broken line in FIG. 6, the other end of the heater wiring 105 is connected to a heater lead wire 178 of an electric wire 177. The two electric wires 171 and 177 are extended to the outside of the outer tube 90 and are connected to the energization terminal 225a and 223a, respectively, of the first heater energization circuit 223. In this case, although the number of the heater lead wires cannot be reduced, the heater wiring 105 can be driven without being affected by a change in the attachment state (the state of electrical conduction) between the mounting metallic member 80 and the attachment boss BOO, which change occurs as a result of attaching or detaching the mounting metallic member 80 or which occurs as a result of elapse of time. Therefore, this modified configuration is advantageous in that the heat generation state of the heater wiring 105 (the heat generation resistor 106) can be stabilized.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

This application is based on Japanese Patent Application No. 2016-011115 filed Jan. 22, 2016, the above-noted application incorporated herein by reference in its entirety.

What is claimed is:

1. A particulate sensor which comprises a flow channel forming body forming a sensor internal flow channel through which a gas under measurement flows, the particulate sensor electrifying particulates present in the sensor internal flow channel and detecting the particulates flowing through the sensor internal flow channel, wherein
the flow channel forming body includes an inner metal tube and an outer metal tube surrounding the inner metal tube from a radially outer side,
a tubular inter-tube gap between the inner metal tube and the outer metal tube forms at least a portion of the sensor internal flow channel, and
the particulate sensor includes a heater member for heating at least one of the inner metal tube and the outer metal tube.

2. The particulate sensor as claimed in claim 1, wherein the heater member includes a main body member formed of an inorganic insulating material, and a heat generation resistor which is embedded in the main body member and generates heat upon energization.

3. The particulate sensor as claimed in claim 1, wherein the heater member is in contact with an outer tube to-be-contacted portion of the outer metal tube and heats the outer metal tube through the outer tube to-be-contacted portion.

4. The particulate sensor as claimed in claim 1, wherein the heater member is in contact with an inner tube to-be-contacted portion of the inner metal tube and heats the inner metal tube through the inner tube to-be-contacted portion.

5. A particulate detection system including the particulate sensor as claimed in claim 1, which comprises means for causing ions generated by gaseous discharge to adhere to particulates contained in the gas under measurement flowing through the sensor internal flow channel to thereby generate electrified particulates, and means for detecting the amount of the particulates contained in the gas under measurement based on a signal current flowing in accordance with the amount of the electrified particulates.
